(19) United States
(12) Patent Application Publication
(10) Pub. No.: US 2003/0231727 A1
(43) Pub. Date: Dec. 18, 2003

(54) Communication method, electronic equipment, and communication program storage medium

(75) Inventor: Masahiro Ito, Higashine (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/320,248

(22) Filed: Dec. 16, 2002

(30) Foreign Application Priority Data
Jun. 12, 2002 (JP) 2002-171647

(51) Int. Cl. H04L 7/00; H04L 7/06

(52) U.S. Cl. 375/364

(57) ABSTRACT

Disclosed are a communication method of transmitting and/or receiving both data and a synchronizing signal for data receiving, and electronic equipment for transmitting and/or receiving both data and a synchronizing signal for data receiving. The communication method and the electronic equipment each comprise a data communication section for transmitting and/or receiving both data and a synchronizing signal for data receiving, and a synchronizing signal monitor section for monitoring whether a time width of a predetermined section of a signal waveform of the synchronizing signal satisfies a predetermined reference.

### BACKGROUND OF THE INVENTION

1. Field of the Invention

The present invention relates to a communication method of transmitting and/or receiving both data and a synchronizing signal for data receiving, electronic equipment for transmitting and/or receiving both data and a synchronizing signal for data receiving, and a communication program storage medium storing a communication program, which is executed in electronic equipment having a hardware for data communications and also having a function of execution of a program to cause the electronic equipment to perform the data communications.

2. Description of the Related Art

Hitherto, there are known two types of data transmission between electronic equipment and electronic equipment, that is, a synchronous transmission system and an asynchronous transmission system. The synchronous transmission system is concerned with a system in which a transmission side transmits a synchronizing signal together with data, and a receiving side receives the data in synchronism with the transmitted synchronizing signal. In the event that the data is not properly received, in other words, there is an error in data transmission, it may happen that retransmission of the data is performed. Japanese Patent Application Laid Open Gazette Hei. 8-221335 proposes a technique in which checking a period of a synchronizing signal enhances a success rate of retransmission at the time of transmission errors. Also as to the asynchronous transmission system, as a technology disclosed in Japanese Patent Application Laid Open Gazette Hei. 9-6725, there is known a technology of using a synchronous transmission system to enhance detection accuracy of transmission errors.

By the way, as a method of detecting data transmission errors between electronic equipment and electronic equipment, there are proposed many technologies. For example, Japanese Patent Application Laid Open Gazette Sho. 63-275074 proposes a technology in which when a series of data is sequentially transmitted, discrepancy of timing between a synchronizing signal and a reference clock signal of electronic equipment managing timings of data transmission is exactly detected, so that omission of individual data and overlapping are detected. However, use of only the technology disclosed in the above-referenced Japanese Patent Application Laid Open Gazette Sho. 63-275074 would make it difficult to detect that contents of data are changed owing to noises or the like. As a typical solution of detecting that contents of data are changed owing to noises or the like, there are known parity check and a method referred to as CRC (Cyclic Redundancy Checking) using constant called generating polynomial. According to any of those parity check and CRC, the transmission side adds redundancy bits after data to be transmitted and then transmits, and the receiving side decides whether contents of the data are exactly transmitted using both the transmitted data and redundancy bits. With respect to the parity check, there are two types of schemes of an even parity and an odd parity. With respect to the CRC, the number of bits of the redundancy bits is varied in accordance with a bit length of the constant used.

Thus, in the event that the parity check is performed, a difference of the adopted schemes between the receiving side and the transmission side would involve erroneous detection of the transmission errors. Also in the event that the CRC is performed, a difference of the used constant between the receiving side and the transmission side would involve erroneous detection of the transmission errors, too.

Further, there is an interface adopting no parity check and CRC.

### SUMMARY OF THE INVENTION

In view of the foregoing, it is an object of the present invention to provide a communication method, electronic equipment, and a communication program storage medium, which are capable of detecting changes of contents of data due to noises and the like, independently of the parity check and the CRC.

To achieve the above-mentioned object, the present invention provides a communication method comprising:

a data communication step that transmits and/or receiving both data and a synchronizing signal for data receiving, and

a synchronizing signal monitor step that monitors whether a time width of a predetermined section of a signal waveform of the synchronizing signal satisfies a predetermined reference.

The communication method of the present invention includes three methods of transmitting both data and a synchronizing signal for data receiving, receiving both data and a synchronizing signal for data receiving, and transmitting and receiving both data and a synchronizing signal for data receiving.

To achieve the above-mentioned object, the present invention provides electronic equipment comprising a data communication section that transmits and/or receiving both data and a synchronizing signal for data receiving, and

a synchronizing signal monitor section that monitors whether a time width of a predetermined section of a signal waveform of the synchronizing signal satisfies a predetermined reference. The electronic equipment of the present invention includes three types of electronic equipment of the transmission side transmitting both data and a synchronizing signal for data receiving, electronic equipment of the receiving side receiving both data and a synchronizing signal for data receiving, and electronic equipment transmitting and receiving both data and a synchronizing signal for data receiving.

In the receiving method having the synchronizing signal monitor step and the electronic equipment of the receiving side having the synchronizing signal monitor section, it is presumed that occurrence of distortion and ringing on the transmitted synchronizing signal brings about degradation of reliability that contents of data received in synchronism with the synchronizing signal are accurate. Accordingly, monitoring the synchronizing signal makes it possible to evaluate the reliability that contents of the data received are accurate, without performing the parity check and CRC. Even in the event that the parity check and CRC are performed, it possible to evaluate the reliability that contents of the data are accurate, before performing the parity check and CRC.

In the transmission method having the synchronizing signal monitor step and the electronic equipment of the transmission side having the synchronizing signal monitor section, it is presumed that satisfaction of the signal waveform of the transmitted synchronizing signal with a predetermined reference may increase reliability that contents of data transmitted in synchronism with the synchronizing signal are accurate. Accordingly, the synchronizing signal is monitored to decide whether the signal waveform of the synchronizing signal satisfies a predetermined reference. As a result, if the synchronizing signal transmitted together with the data satisfies the predetermined reference, it is possible to ensure that contents of data are accurate on the transmitted data at the transmitted time point immediately after the data is transmitted.

In the communication method of the present invention, it is preferable that the synchronizing signal monitor step monitors whether a time width of a predetermined section of the synchronizing signal is between a predetermined permissible minimum time width and a predetermined permissible maximum time width. In the electronic equipment of the present invention, it is preferable that the electronic equipment further comprises a reference storage section that stores reference information representative of a permissible minimum time width and a permissible maximum time width of the predetermined section, and said synchronizing signal monitor section monitors whether a time width of a predetermined section of the synchronizing signal is between the permissible minimum time width and the permissible maximum time width represented by the reference information stored in said reference storage section.

In the communication method of the present invention and the electronic equipment of the present invention, it is preferable that said synchronizing signal is a clock signal, and said synchronizing signal monitor step monitors, as the time width of the predetermined section, one or more selected from among a rise time, a fall time, a time width of an H-level, a time width of an L-level, and a predetermined transmission period, of the clock signal.

With respect to the selection of items (rise time of the clock signal, and the like) to be monitored in form of time width of the predetermined section, it is effective that the item is decided in view of the balance between a degree of reliability of data contents and a processing load of the synchronizing signal monitor section.

In the communication method of the present invention, it is preferable that said communication method further comprises a receipt result report step that reports a monitored result by said synchronizing signal monitor step to a party of communications. In the electronic equipment of the present invention, said electronic equipment further comprises a communication result report section that reports a monitored result by said synchronizing signal monitor section to a party of communications.

Performing such a report makes it possible for the party of communications to know reliability of data. And in the event that reliability of data is low, it is possible to perform necessary processing such as retransmission processing for data and processing of stopping processing of received data.

To achieve the above-mentioned object, the present invention provides a communication program storage medium storing a communication program to be executed by electronic equipment having hardware for data communications and functions of executing programs, wherein said communication program causes said electronic equipment to perform the data communications, said electronic equipment comprising:

a data communication section that transmits and/or receiving both data and a synchronizing signal for data receiving, and

a synchronizing signal monitor section that monitors whether a time width of a predetermined section of a signal waveform of the synchronizing signal satisfies a predetermined reference.

When the communication program stored in the communication program storage medium of the present invention is installed in the electronic equipment having function of executing a program and is executed, the electronic equipment can be operated as the electronic equipment.

In the communication program storage medium according to the present invention as mentioned above, it is preferable that said electronic equipment further comprises a reference storage section that stores reference information representative of a permissible minimum time width and a permissible maximum time width of the predetermined section, and

wherein said synchronizing signal monitor section monitors whether a time width of a predetermined section of the synchronizing signal is between the permissible minimum time width and the permissible maximum time width represented by the reference information stored in said reference storage section.

### BRIEF DESCRIPTION OF THE DRAWINGS

FIG. 1 is a perspective view of a personal computer according to an embodiment of electronic equipment of the present invention, to which a magneto-optical disk (MO) also according to an embodiment of electronic equipment of the present invention is connected.

FIG. 2 shows hardware construction views of the personal computer and the magneto-optical disk shown in FIG. 1.

FIG. 3 is a view showing an embodiment of a communication program stored in a communication program storage medium of the present invention.

FIG. 4 is a functional block diagram of an embodiment of electronic equipment of the present invention.

FIG. 5 is a flowchart useful for understanding processes of data communications to be performed in the electronic equipment shown in FIG. 4.

FIG. 6 is a circuit diagram of a portion for performing an error detection in data transmission, of the SCSI controller provided on the personal computer shown in FIG. 2.

FIG. 7(a) and FIG. 7(b) are a view showing a transition of data in a data line wherein a series of data are sequentially transmitted, and a view showing a data strobe signal, respectively.

FIG. 8 is a flowchart useful for understanding set up processing for the magneto-optical disk shown in FIG. 2, of the personal computer shown in FIG. 2 connected to the magneto-optical disk.

FIG. 9 is a flowchart useful for understanding read command processing of the magneto-optical disk upon receipt of read command from the host.

FIG. 10 is a view showing an outline of a flow of processing from the set up processing explained referring to FIG. 8 to the read command processing explained referring to FIG. 9.

FIG. 11 is a view showing an example of a signal waveform of a data strobe signal.

FIG. 12 is a view showing another example of a signal waveform of a data strobe signal.

FIG. 13 is a view showing an outline of a flow of processing subsequent to the flow of the processing explained referring to FIG. 10.

FIG. 14 is a flowchart useful for understanding write command processing of the magneto-optical disk upon receipt of write command from the host.

### DETAILED DESCRIPTION OF PREFERRED EMBODIMENTS

Embodiments of the present invention will be described with reference to the accompanying drawings.

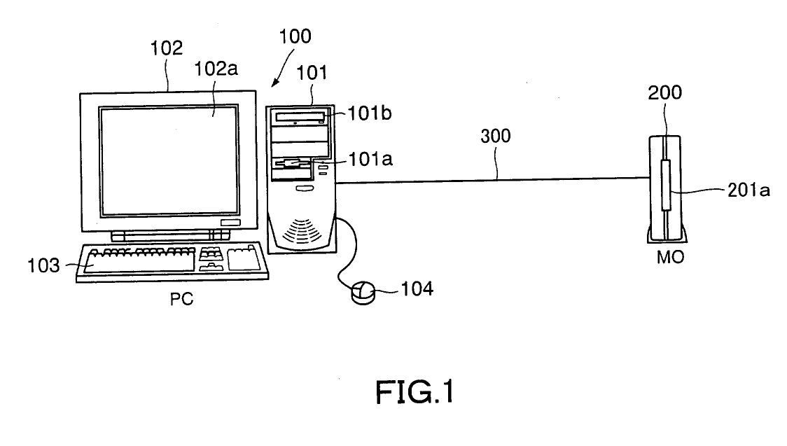

FIG. 1 is a perspective view of a personal computer according to an embodiment of electronic equipment of the present invention, to which a magneto-optical disk (MO) unit also according to an embodiment of electronic equipment of the present invention is connected.

A personal computer 100 comprises: a main frame 101 incorporating therein a CPU (Central Processing Unit), a RAM (Random Access Memory), and a hard disk; a display unit 102 for displaying images and strings of characters on a display screen 102a in accordance with instructions from the main frame 101; a keyboard 103 for inputting user's instructions and character information to the personal computer; and a mouse 104 for inputting orders associated with icons or the like displayed on positions on the display screen 102a when the positions are designated.

The main frame 101 of the personal computer 100 comprises, on the outside appearance, a flexible disk (FD), a flexible disk mounting slot 101a onto which CD-ROM is loaded, and a CD-ROM mounting slot 101b. Inside the main frame 101, there are incorporated a flexible disk drive for driving the flexible disk loaded through the flexible disk mounting slot 101a, and a CD-ROM drive for driving the CD-ROM loaded through the CD-ROM mounting slot 101b.

The personal computer 100 is provided with a SCSI (Small Computer System Interface) connector and an RS-232C (Recommended Standard 232C) connector.

A magneto-optical disk (MO) unit 200 comprises an F-ROM (flash memory) as well as the CPU and the RAM (random access memory). The magneto-optical disk (MO) unit 200 further comprises, on the outside appearance, an MO mounting slot 201a onto which a magneto-optical disk is loaded, and incorporates therein an MO drive for driving and accessing the loaded magneto-optical disk. The F-ROM stores therein a program for performing read and write of information for the magneto-optical disk. The CPU executes the program. The RAM is used as a working area for the program. The magneto-optical disk unit 200 is provided with a SCSI (Small Computer System Interface) connector and an RS-232C (Recommended Standard 232C) connector, in a similar fashion to that of the personal computer 100 shown in FIG. 1.

The SCSI connector of the personal computer 100 shown in FIG. 1 is connected to the SCSI connector of the magneto-optical disk unit 200 shown in FIG. 1 via a SCSI cable 300.

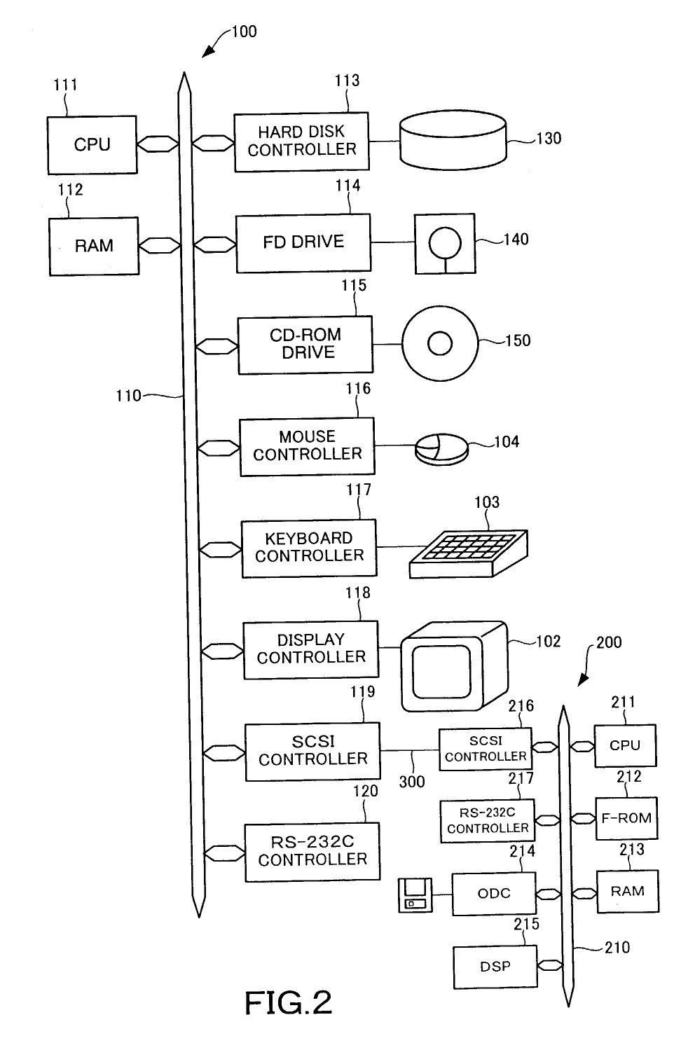

FIG. 2 shows hardware construction views of the personal computer and the magneto-optical disk unit shown in FIG. 1.

The hardware construction view of the personal computer 100 shows a central processing unit (CPU) 111, a RAM 112, a hard disk controller 113, a flexible disk (FD) drive 114, a CD-ROM drive 115, a mouse controller 116, a keyboard controller 117, a display controller 118, an SCSI controller 119, and an RS-232 controller 120. Those are connected to one another through a bus 110.

The hard disk controller 113 accesses a hard disk 130 of a hard disk drive incorporated in the main frame of the personal computer 100. The flexible disk drive 114 and the CD-ROM drive 115 access, as described referring to FIG. 1, a flexible disk 140 and a CD-ROM 150, which are loaded through the flexible disk mounting slot 101a and the CD-ROM mounting slot 101b, respectively.

The hardware construction view of the magneto-optical disk unit 200 shown in FIG. 1 shows a CPU 211, an F-ROM 212, a RAM 213, an ODC (optical magnetic disk controller) 214, a DSP (digital signal control circuit) 215, an SCSI controller 216, and an RS-232 controller 217. Those are connected to one another through a bus 210.

The SCSI controller 119 of the personal computer 100 is connected to the SCSI controller 216 of the magneto-optical disk unit 200 via a SCSI cable 300. Data transmission is performed between the personal computer 100 and the magneto-optical disk unit 200 via the SCSI cable 300. Those SCSI controllers 119 and 216 perform data transmission in accordance with a standard of SCSI, and also perform an error detection of the data transmission. Details of such an error detection of the data transmission will be described later. In a similar fashion to that of those SCSI controllers 119 and 216, the RS-232 controller 120 and 217, which are provided on the personal computer 100 and the magneto-optical disk unit 200, respectively, control data transmission in accordance with a standard of RS-232.

The ODC (optical magnetic disk controller) 214 provided on the magneto-optical disk unit 200 controls read and write of information for the magneto-optical disk. The ODC 214 receives a command transmitted to the SCSI controller 216 of the magneto-optical disk unit 200, decodes the received command, and executes the operation indicated by the command. The ODC 214 performs the parity check for writing data, a CRC (cyclic redundancy checking) and the like. The CPU 211 and the DSP 215, which are provided on the magneto-optical disk unit 200, control basic operations of the magneto-optical disk unit 200, such as rotary driving, taking-in and sending of a magneto-optical disk, and tracking and focusing for the magneto-optical disk.

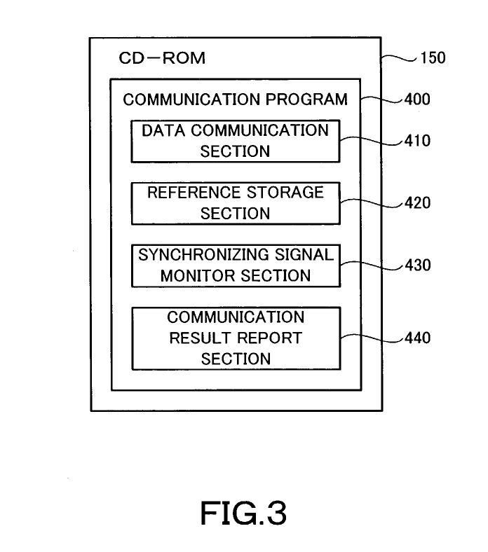

FIG. 3 is a view showing an embodiment of a communication program stored in a communication program storage medium of the present invention.

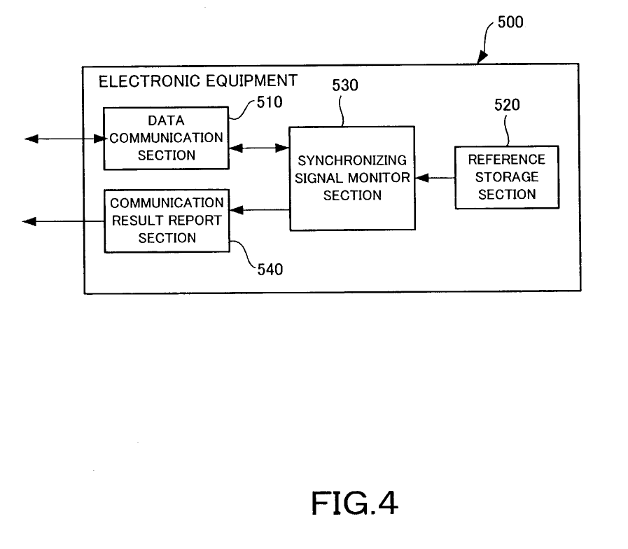

A communication program 400 is stored in the CD-ROM 150. The communication program 400 comprises a data communication section 410, a reference storage section 420, a synchronizing signal monitor section 430, and a communication result report section 440. Functions of the sections constituting the communication program 400 will be explained in conjunction with functions of the sections constituting the electronic equipment 500 shown in FIG. 4.

The communication program 400 shown in FIG. 3 is stored in the CD-ROM 150, and is up loaded onto the personal computer 100 shown in FIG. 1 when the CD-ROM 150 is loaded through the CD-ROM mounting slot 101b of the personal computer 100 and is accessed by the CD-ROM drive 115 shown in FIG. 2. The communication program 400, which is up loaded onto the personal computer 100, is stored in the hard disk 130 of the personal computer 100. To execute the communication program 400, the communication program 400 stored in the hard disk 130 is read and developed in RAM 112 so as to be executed by the CPU 111.

The communication program 400 is not always up loaded on the personal computer 100 from a state that it is stored in the CD-ROM 150, and it is acceptable that the communication program 400 is up loaded on the personal computer 100 from a state that it is stored in another portable type of storage medium (for example, FD 140 shown in FIG. 2), or it is also acceptable that the personal computer 100 shown in FIG. 1 and FIG. 2 is connected to a communication network such as internet, and the communication program 400 is loaded on the personal computer 100 via the communication network, further or alternatively it is acceptable that the communication program 400 is stored in the hard disk 130 of the personal computer 100 beforehand. In effect, anyone is acceptable, as the communication program 400, which is executed in the personal computer 100.

FIG. 4 is a functional block diagram of an embodiment of electronic equipment of the present invention.

Electronic equipment 500 shown in FIG. 4 is implemented in the personal computer 100 shown in FIG. 1 and FIG. 2 when the communication program 400 in FIG. 3 is executed in the personal computer 100.

The electronic equipment 500 shown in FIG. 4 comprises a data communication section 510, a reference storage section 520, a synchronizing signal monitor section 530, and a communication result report section 540. The data communication section 510, the reference storage section 520, the synchronizing signal monitor section 530, and the communication result report section 540 correspond to the data communication section 410, the reference storage section 420, the synchronizing signal monitor section 430, and the communication result report section 440, respectively, which are shown in FIG. 3. The respective sections constituting the electronic equipment 500 shown in FIG. 4 are constituted of compounds of a hard ware of the personal computer 100 shown in FIG. 1 and FIG. 2, an operating system (OS) operating in the personal computer 100, and the communication program 400 shown in FIG. 3 as the application program to be executed on the OS. To the contrary, the respective sections 410 to 440 constituting the communication program 400 shown in FIG. 3 are constituted of only the application program of the compounds. The functions of the sections 410 to 440 constituting the communication program 400 shown in FIG. 3, when the communication program 400 is executed in the personal computer, are the same as those of the functions of the sections 510 to 540 constituting the electronic equipment 500 shown in FIG. 4, respectively. Accordingly, the explanation of the respective functions of the sections 510 to 540 constituting the electronic equipment 500 shown in FIG. 4 serves as the explanation of the respective functions of the sections 410 to 440 constituting the communication program 400 shown in FIG. 3.

The data communication section 510 constituting the electronic equipment 500 shown in FIG. 4 transmits and/or receives both data and a synchronizing signal (here a clock signal) for receiving of the data. That is, the data communication section 510 corresponds to a data receiving section when data receiving is performed, and the data communication section 510 corresponds to a data transmission section when data transmission is performed. The reference storage section 520 shown in FIG. 4 stores reference information representative of permissible minimum time width and permissible maximum time width of a predetermined section of a synchronizing signal for data receiving. The synchronizing signal monitor section 530 shown in FIG. 4 monitors whether a time width of a predetermined section of a synchronizing signal for data receiving is between the permissible minimum time width and the permissible maximum time width represented by the reference information stored in the reference storage section 520. That is, the synchronizing signal monitor section 530 monitors a time width of a predetermined section of a clock signal or a synchronizing signal for data receiving. Monitoring objects are one or ones selected from among a rise time, a fall time, a time width of an H-level, a time width of an L-level, and a predetermined transmission period, of the clock signal. The communication result report section 540 shown in FIG. 4 reports a monitored result by the synchronizing signal monitor section 530 to the party of the communication through the data communication section 510.

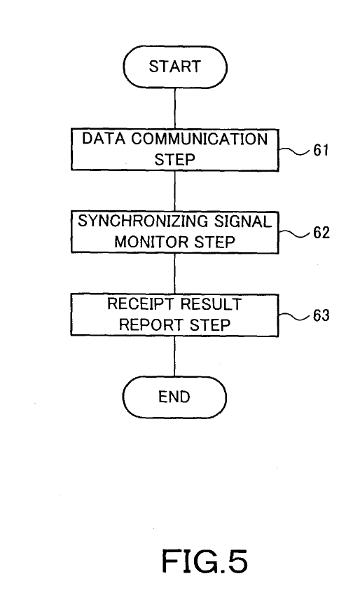

FIG. 5 is a flowchart useful for understanding processes of data communications to be performed in the electronic equipment shown in FIG. 4.

As shown in FIG. 5, the data communication performed in the electronic equipment 500 shown in FIG. 4 comprises three steps of a data communication step 61, a synchronizing signal monitor step 62, and a receipt result report step 63. The data communication step 61 transmits and/or receives both data and a synchronizing signal (here a clock signal) for receiving of the data. That is, the data communication step 61 corresponds to a data receiving step when data receiving is performed, and the data communication step 61 corresponds to a data transmission step when data transmission is performed. The synchronizing signal monitor step 62 monitors whether a time width of a predetermined section of a synchronizing signal for data receiving is between the permissible minimum time width and the permissible maximum time width represented by the reference information stored in the reference storage section 520 shown in FIG. 5. That is, the synchronizing signal monitor step 62 monitors a time width of a predetermined section of a clock signal or a synchronizing signal for data receiving. Monitoring objects are one or ones selected from among a rise time, a fall time, a time width of an H-level, a time width of an L-level, and a predetermined transmission period, of the clock signal. Incidentally, it is acceptable that while the data communication step 61 is executed, the synchronizing signal monitor step 62 is simultaneously executed. The communication result report step 63 reports a monitored result by the synchronizing signal monitor step 62 to the party of the communication.

Next, there will be explained in detail the SCSI controller 119 provided on the personal computer 100 shown in FIG. 2.

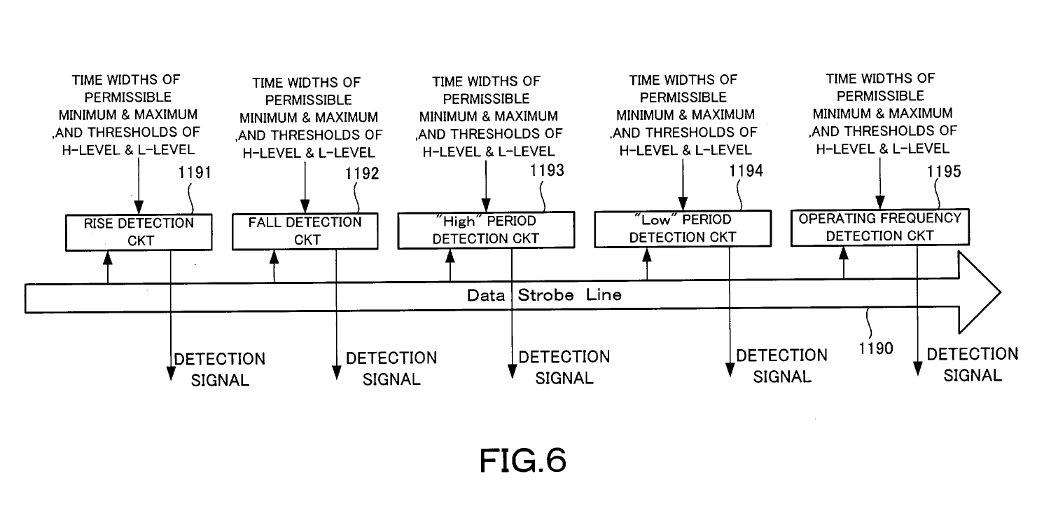

FIG. 6 is a circuit diagram of a portion for performing an error detection in data transmission, of the SCSI controller provided on the personal computer shown in FIG. 2.

The SCSI controller 119 provided on the personal computer 100 shown in FIG. 2 is provided with a data strobe line 1190. The SCSI controller 119 is further provided with a data line (not illustrated) for transmitting data in addition to the data strobe line 1190. A portion of performing an error detection of data transmission, of the SCSI controller 119 comprises a rise detection circuit 1191, a fall detection circuit 1192, a “High” period detection circuit 1193, a “Low” period detection circuit 1194, and an operating frequency detection circuit 1195.

When the personal computer 100 shown in FIG. 2 reads data stored in the magneto-optical disk loaded on the magneto-optical disk unit 200 shown in FIG. 2, the data stored in the magneto-optical disk is transmitted together with the data strobe signal from the magneto-optical disk unit 200 via the SCSI cable 300. The data strobe signal is the clock signal generated in the magneto-optical disk unit 200. A portion of performing of data transmission, of the SCSI controller 119 provided on the personal computer 100 receives the data stored in the magneto-optical disk in synchronism with the data strobe signal transmitted together with the data. The received data is fed to the data line (not illustrated), while the data strobe signal is fed to the data strobe line 1190. On the other hand, when data of the personal computer 100 shown in FIG. 2 is written into the magneto-optical disk loaded on the magneto-optical disk unit 200 shown in FIG. 2, data to be written into the magneto-optical disk is transmitted together with the data strobe signal from the personal computer 100. The SCSI controller 119 of the personal computer 100 further comprises a clock signal generator (not illustrated), that generates the data strobe signal. The data strobe signal thus generated is transmitted via the data strobe line 1190 to the portion of performing the data transmission, of the SCSI controller 119. Data to be written into the magneto-optical disk is transmitted via the data line (not illustrated) to the portion of performing the data transmission. The portion of performing the data transmission, of the SCSI controller 119 provided on the personal computer 100 transmits the data to be written into the magneto-optical disk to the SCSI controller 216 of the magneto-optical disk unit 200 together with the data strobe signal.

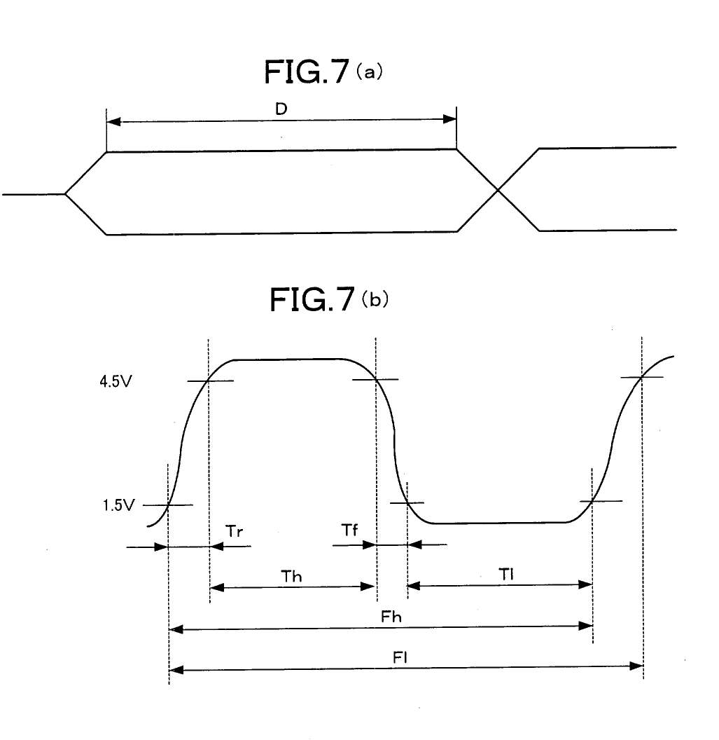

FIG. 7(a) is a view showing a transition of data in a data line wherein a series of data are sequentially transmitted, and FIG. 7(b) is a view showing a data strobe signal.

In FIG. 7(a) and FIG. 7(b), horizontal directions of the figures are denoted as a time axis, and the time axis of FIG. 7(a) is harmonized with the time axis of FIG. 7(b). In FIG. 7(b), a vertical direction of the figure is denoted as an axis representative of a voltage value.

In FIG. 7(a), a parallel line indicates a section D, wherein individual data of a series of data in the data line is decided. In the event that the personal computer 100 shown in FIG. 2 is of the receiving side, the portion of performing the data transmission, of the SCSI controller 119 provided on the personal computer 100 triggers a rise of the data strobe signal shown in FIG. 7(b) to receive individual data. On the other hand, in the event that the personal computer 100 is of the transmission side, the portion of performing the data transmission transmits the data together with the data strobe signal in such a manner that the rise of the data strobe signal is in synchronism with the decided section of the data.

Next, referring to FIG. 7(b) there will be explained the detection circuits 1191 to 1195 shown in FIG. 6. The detection circuits 1191 to 1195 each detect a predetermined section of the data strobe signal in accordance with decisions of H-level and L-level of the data strobe signal by thresholds. The hard disk 130 of the personal computer 100 stores therein a threshold for deciding H-level and a threshold for deciding L-level of the data strobe signal. While it is acceptable that those thresholds are different in value from one another on each detection circuit, FIG. 7(b) exemplarily shows that a threshold for H-level is 4.5V and a threshold for L-level is 1.5V on any detection circuits. The detection circuits 1191 to 1195 each determine a time width of a detected predetermined section using a clock signal higher in speed than the data strobe signal. The hard disk 130 of the personal computer 100 stores therein information for designating a detection circuit to be operated at the time of the data transmission. At the time of the data transmission, of those five detection circuits 1191 to 1195, only the detection circuit designated by the information is operated. According to the present embodiment, it is assumed that at the time of the data transmission all the detection circuits are operated. The rise detection circuit 1191 shown in FIG. 6 receives from the hard disk 130 two thresholds of an H-level of threshold and an L-level of threshold, and measures a time width (a rise time Tr) since a value of the data strobe signal reaches the L-level of threshold in a rise section of a signal until the value reaches the H-level of threshold. The fall detection circuit 1192 also receives the two thresholds, and measures a time width (a fall time Tf) since a value of the data strobe signal lowers to the H-level of threshold in a fall section of the signal until the value lowers to the L-level of threshold. The “High” period detection circuit 1193 receives only the H-level of threshold of the two thresholds, and measures a time width (a time width Th of the H-level) since a value of the data strobe signal reaches the H-level of threshold in the rise section of the signal until the value lowers to the H-level of threshold in the fall section. The “Low” period detection circuit 1194 receives only the L-level of threshold of the two thresholds, and measures a time width (a time width Tl of the L-level) since a value of the data strobe signal lowers to the L-level of threshold in the fall section of the signal until the value reaches the H-level of threshold in the rise section. The operating frequency detection circuit 1195 receives only the L-level of threshold, and measures a time width Fh since a value of the data strobe signal reaches the L-level of threshold in the rise section of the signal until the value reaches again the L-level of threshold in the next rise section, that is, measures a period of the data strobe signal. Incidentally, any one is acceptable, as the operating frequency detection circuit 1195, which measures a predetermined transmission period of the data strobe signal, for example, a period, and it is acceptable that any section of a signal wave of the data strobe signal is utilized for measurement. As the detection circuit, it is not restricted to the detection circuits 1191 to 1195, any one is acceptable, as the detection circuit, which measures a time width of a predetermined section of the signal wave of the data strobe signal, and for example, it is acceptable that the detection circuit measures a time width Fl since a value of the data strobe signal reaches the L-level of threshold in the rise section of the signal until the value reaches the H-level of threshold in the next rise section.

From a standpoint that the more the time widths (Tr, etc.) measured by the detection circuits 1191 to 1195 are out of the time widths computed from the clock frequency of the data strobe signal, the more a reliability that contents of the data synchronized with the data strobe signal is exact is lowered, the hard disk 130 of the personal computer 100 records permissible limits on the time widths Tr, Tf, Th, Tl, and Fh measured by the detection circuits using the permissible minimum time width and the permissible maximum time width. The selected detection circuits derive from the hard disk 130 the permissible minimum time width and the permissible maximum time width on the time widths to be measured, and monitor whether the measured time widths are between the permissible maximum time width and the permissible maximum time width.

The detection circuits 1191 to 1195 can output their associated monitor results in form of detection signals, respectively. The hard disk 130 of the personal computer 100 stores therein information indicative of whether it causes the detection circuits to output the detection signals. The detection circuits 1191 to 1195 output or do not output the detection signals in accordance with the information. Here, it is assumed that the detection circuits 1191 to 1195 output the detection signals. In the event that the personal computer 100 is of the receiving side, the detection signal is transmitted to the transmission source of the received data. And in the event that the personal computer 100 is of the transmission side, the detection signal is transmitted to the transmission destination of the transmitted data. Thus, this way makes it possible for the party received the detection signal to decide whether data transmission is performed normally. That is, when the party received the detection signal indicative of that the time width is between the permissible minimum time width and the permissible maximum time width, it can be considered that the data transmission is performed normally. On the other hand, when the party received the detection signal indicative of that the time width is out of between the permissible minimum time width and the permissible maximum time width, it can be considered that the data transmission is not performed normally. Saving of the monitor result based on the detection signal into the hard disk 130 of the personal computer 100 makes it possible to confirm statistics information as to whether there is a possibility that transmission errors occurred in the past, and thereby confirming a quality of the transmission system.

Incidentally, while the hard disk 130 of the personal computer 100 records at the stage of forwarding of a factory thresholds of the detection circuits, values of the permissible minimum time width and the permissible maximum time width, information designating detection circuits to be operated, and information indicative of whether it causes the detection circuits to output the detection signals, it is permitted to alter those values and the contents of the information by operation of keyboard 103 and the mouse 104.

The circuit of the portion of performing an error detection of data transmission shown in FIG. 6, of the SCSI controller 119 provided on the personal computer 100, as mentioned above, is also provided on the portion of performing an error detection of data transmission, of the SCSI controller 216 provided on the magneto-optical disk unit 200, shown in FIG. 2. In a similar fashion to that of the hard disk 130 of the hard disk drive of the personal computer 100 shown in FIG. 2, it is acceptable that the F-ROM 212 of the magneto-optical disk unit 200 also records various types of values and information beforehand. However, here, it is assumed that the F-ROM 212 does not record various types of values and information beforehand.

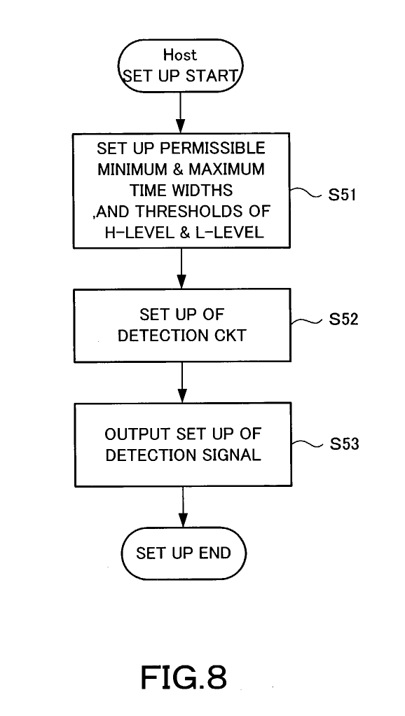

First, there will be explained a set up processing of recording those various types of values and information into the F-ROM 212 referring to FIG. 8.

FIG. 8 is a flowchart useful for understanding set up processing for the magneto-optical disk shown in FIG. 2, of the personal computer shown in FIG. 2 connected to the magneto-optical disk.

A set up processing program for executing a set up processing routine shown in FIG. 8 is installed in the hard disk 130 of the host equipment (here the personal computer 100 shown in FIG. 2), which is connected to the magneto-optical disk unit 200. The set up processing routine shown in FIG. 8 is initiated when the set up processing program starts. The set up processing program is supplied via a portable type of disk or Internet and is installed in the hard disk.

First, a user designates on the personal computer 100 detection circuits to be operated at the time of data transmission from among the five detection circuits provided on the magneto-optical disk unit 200. With respect to the designated detection circuit, the user designates on the personal computer 100 thresholds of the H-level and the L-level, and values of the permissible minimum time width and the permissible maximum time width. Further, the user selects on the personal computer 100 as to whether the detection circuit outputs the monitor result in form of a detection signal.

When the set up for those various types of values is performed, the personal computer 100 performs the set up processing for the magneto-optical disk unit 200 in accordance with the results of the set up for those various types of values.

Step S51 performs set up of thresholds of H-level and L-level, and values of the permissible minimum time width and the permissible maximum time width. That is, the thresholds of H-level and L-level, and the values of the permissible minimum time width and the permissible maximum time width, which are set up on the personal computer 100, are transmitted from the SCSI controller 119 of the personal computer 100 via the SCSI cable 300 to the SCSI controller 216 of the magneto-optical disk unit 200.

Next, step S51 sets up one or more detection circuits to be operated at the time of data transmission from among the five detection circuits provided on the magneto-optical disk unit 200. That is, information representative of the designated detection circuits on the personal computer 100 is transmitted from the SCSI controller 119 of the personal computer 100 via the SCSI cable 300 to the SCSI controller 216 of the magneto-optical disk unit 200, in a similar fashion to that of the above-mentioned values.

Next, step S53 performs set up as to whether the detection circuit outputs the monitor result in form of a detection signal. That is, information indicative of whether the detection circuit outputs the monitor result in form of a detection signal is also transmitted utilizing the SCSI interface, in a similar fashion to that of the step S52.

The values and information transmitted in the above-mentioned steps are recorded onto the F-ROM 212 of the magneto-optical disk unit 200.

When the set up of the step S53 is completed, the set up processing routine is terminated.

With respect to transmissions of the various types of values and information from the personal computer 100 to the magneto-optical disk unit 200, it is acceptable to utilize RS-232 interface as well as the SCSI interface. Or alternatively, in the event that the personal computer 100 and the magneto-optical disk unit 200 are each provided with an interface such as ATAPI (ATA Packet Interface), USB (Universal Serial Bus), and IEEE 1394, it is acceptable to utilize those interfaces.

Next, there will be explained data transmission in the magneto-optical disk unit 200 subjected to such a set up.

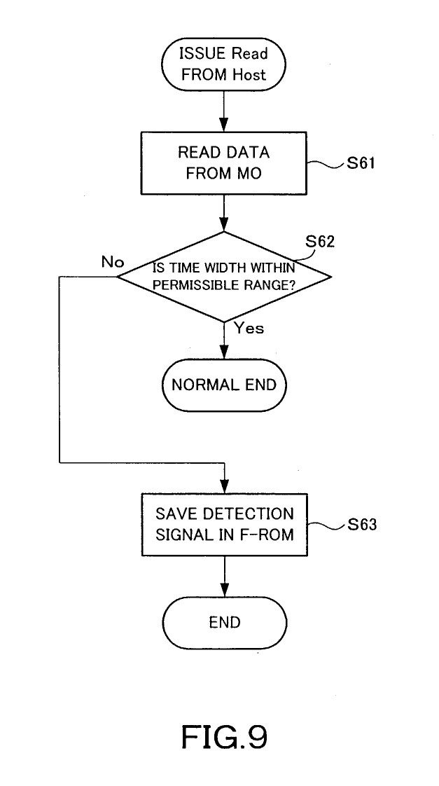

First, in conjunction with FIG. 9, there will be explained a case where the personal computer 100 (host) shown in FIG. 2 reads data recorded on the magneto-optical disk loaded onto the magneto-optical disk unit 200 shown in FIG. 2, that is, a case where the magneto-optical disk unit 200 receives a read command from the host. In this case, the magneto-optical disk unit 200 is of the transmission side.

FIG. 9 is a flowchart useful for understanding read command processing of the magneto-optical disk upon receipt of read command from the host.

The read command is transmitted from the personal computer 100 via the SCSI cable 300 to the SCSI controller 216 of the magneto-optical disk unit 200. A read command processing routine shown in FIG. 9 starts whenever the magneto-optical disk unit 200 receives the read command.

In the read command processing, first, the ODC 214 shown in FIG. 2 reads data from the magneto-optical disk loaded on the MO mounting slot 201a shown in FIG. 1 in accordance with the transmitted read command (step S61). The data read from the magneto-optical disk is transmitted from the ODC 214 to the portion of performing data transmission, of the SCSI controller 216 of the magneto-optical disk unit 200. The SCSI controller 216 of the magneto-optical disk unit 200 is also provided with a clock signal generator in a similar fashion to that of the SCSI controller 119 of the personal computer 100 shown in FIG. 2. The clock signal generator generates the data strobe signal. The data strobe signal thus generated is also transmitted to the portion of performing the data transmission. Of the detection circuits of the magneto-optical disk unit 200, the detection circuit designated to be operated at the time of data transmission derives various types of values from the F-ROM 212, and measures time width of a predetermined section of a signal wave of a data strobe signal, just before the data strobe signal is fed to the portion of performing data transmission of the SCSI controller 216, and decides whether the measured time width is between the derived permissible minimum time width and permissible maximum time width (step S62). The F-ROM 212 of the magneto-optical disk unit 200 records information indicating that the detection circuits output their associated monitor results in form of detection signals. When the decision is made in the step S62, the detection circuit outputs the detection signal representative of the decision result. The outputted detection signal is transmitted to the personal computer 100 as well as the CPU 211 of the magneto-optical disk unit 200. In the event that there is detected the detection signal indicating that the time width is within the permissible limit, it can be considered that a reliability of the data transmitted in synchronism with the data strobe signal is high, and thus the read command processing is normally terminated. On the other hand, in the event that there is detected the detection signal indicating that the time width is out of the permissible limit, the monitor result based on the detection signal is saved into the F-ROM 212 of the magneto-optical disk unit 200 (step S63), and the read command processing is terminated. In this case, it is considered that a reliability of the data transmitted in synchronism with the data strobe signal is low, and thus it is preferable that the CPU 211 provided on the magneto-optical disk unit 200 causes ODC 214 to execute again the data read processing in the step S61, or alternatively it is preferable that the personal computer 100, which received the detection signal, transmits again to the magneto-optical disk unit 200 the same content of read command as that of the read command previously transmitted.

Here, with respect to a case where the set up processing, which has been explained in conjunction with FIG. 8, is executed in form of an initial set up, and thereafter the read command processing, which has been explained in conjunction with FIG. 9, is executed in accordance with the initial set up, it will be more concretely explained.

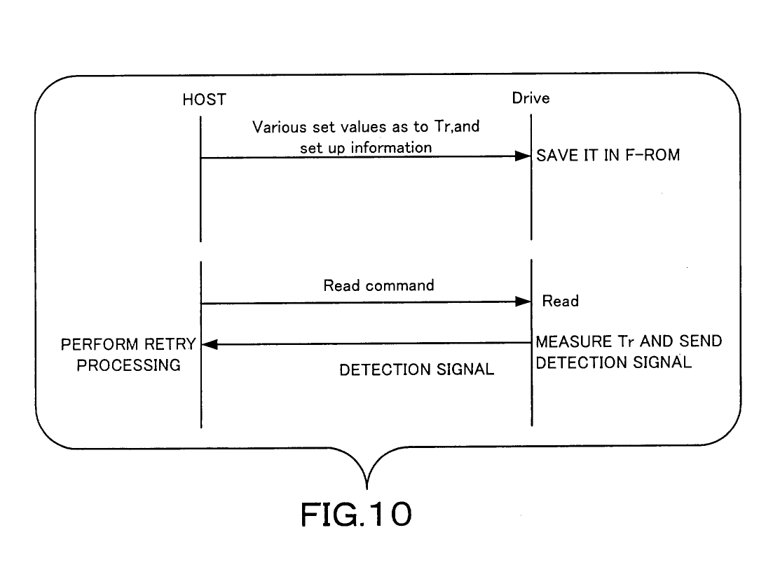

FIG. 10 is a view showing an outline of a flow of processing from the set up processing explained referring to FIG. 8 to the read command processing explained referring to FIG. 9.

On the personal computer 100 shown in FIG. 2, as the circuit to be operated at the time of data transmission, of the five detection circuits provided on the magneto-optical disk unit 200, only the rise detection circuit 1191 for measuring the rise time Tr is designated. As the threshold of H-level for the rise detection circuit 1191, 4.5V is set up. And as the threshold of L-level, 1.25V is set up. Further, there are set up values of the permissible minimum time width and the permissible maximum time width for the time width measured by the rise detection circuit 1191. Furthermore, it is selected that the monitor result by the detection circuit is outputted in form of a detection signal.

First, the personal computer 100 (“HOST” in FIG. 10) executes the set up processing shown in FIG. 8 for the magneto-optical disk unit 200 (“Drive” in FIG. 10). The F-ROM 212 of the magneto-optical disk unit 200 is in a state that various types of values and information as to the detection circuit are not yet recorded, and thus the set up processing offers the initial set up. The initial set up causes the F-ROM 212 of the magneto-optical disk unit 200 to record 4.5V as the threshold of H-level and 1.25V as the threshold of L-level, for the rise detection circuit 1191. Further it is recorded that the values of the permissible minimum time width and the permissible maximum time width for the time width measured by the rise detection circuit 1191, and the monitor result by the detection circuit are output in form of a detection signal.

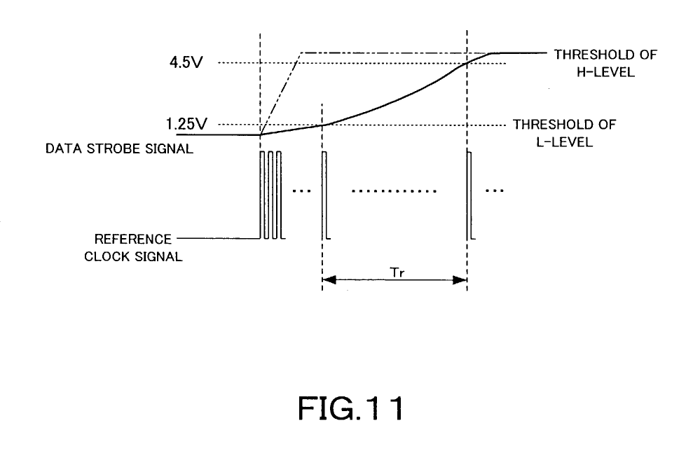

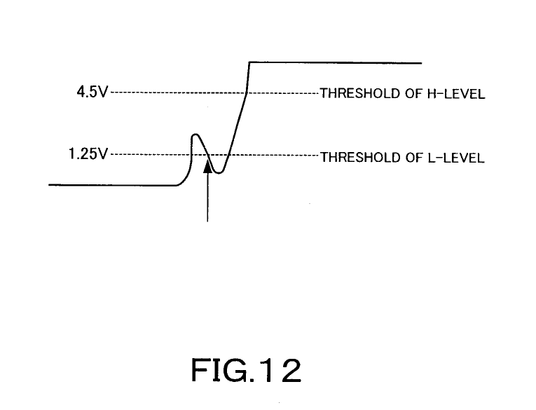

Thus, after the initial set up is made, upon receipt of the read command from the personal computer 100, the magneto-optical disk unit 200 executes the read command processing shown in FIG. 9. Here, there will be described in detail the detection processing for the rise time Tr of the read command processing in conjunction with FIG. 11 and FIG. 12.

FIG. 11 is a view showing an example of a signal waveform of a data strobe signal.

Upper FIG. 11, there is shown a data strobe signal. Two-dot chain line shows a waveform of the data strobe signal on a design. A solid line shows a distorted waveform. Here, there will be explained by way of example the distorted waveform shown by the solid line. In FIG. 11, below the data strobe signal, there is shown a reference clock signal, which is used when the rise time Tr of the data strobe signal. In FIG. 11, the horizontal direction of the figure denotes the time axis, and the vertical direction of the figure denotes the axis representative of voltage values. In FIG. 11, the time axis of the data strobe signal is harmonized with the time axis of the reference clock signal.

The rise detection circuit 1191 first decides whether the value of the data strobe signal reaches 1.25V whenever the reference clock signal shown in FIG. 11 rises. When it is decided that the value of the data strobe signal reaches 1.25V, the rise detection circuit 1191 starts the count of the reference clock signal. Subsequently, the rise detection circuit 1191 decides whether the value of the data strobe signal reaches 4.5V whenever the reference clock signal rises. Simultaneously, the rise detection circuit 1191 monitors whether the value of the data strobe signal goes down to 1.25V.

When it is decided that the value of the data strobe signal reaches 4.5V, the rise detection circuit 1191 terminates the count of the reference clock signal. As soon as the rise detection circuit 1191 terminates the count of the reference clock signal, the rise detection circuit 1191 computes the rise time Tr from the counted value of the reference clock signal, and decides whether the computed rise time Tr is between the permissible minimum time width and the permissible maximum time width. As to the distorted data strobe signal, which is indicated by the solid line, the rise time Tr measured by the rise detection circuit 1191 is longer than the permissible maximum time width. And thus, the rise detection circuit 1191 immediately outputs the detection signal indicative of that matter.

On the other hand, when the value of the data strobe signal goes down to 1.25V, the rise detection circuit 1191 clears the counted value of the reference clock signal without computing the rise time Tr, and immediately outputs the detection signal indicative of such a matter that the rise time is out of between the permissible minimum time width and the permissible maximum time width.

FIG. 12 is a view showing another example of a signal waveform of a data strobe signal.

The data strobe signal shown in FIG. 12 goes down to 1.25V before reaching 4.5V after reaching 1.25V once wing to an influence of reflection and the like. For this reason, the rise detection circuit 1191 outputs the detection signal indicative of such a matter that the rise time is out of between the permissible minimum time width and the permissible maximum time width, at the time when the value of the data strobe signal goes down to 1.25V (cf. the arrow in the figure).

Now returning to FIG. 10, the detection signal outputted from the rise detection circuit 1191 is transmitted to the personal computer 100. When the personal computer 100 detects from the transmitted detection signal such a matter that the rise time Tr is out of the permissible range, the personal computer 100 executes a retry processing in which read command of the same content as that of the read command transmitted previously is transmitted again to the magneto-optical disk unit 200.

In order to enhance the accuracy of detection of change of data contents owing to noises or the like, a user designates on the personal computer 100 one or more detection circuits from among four detection circuits excepting the already designated rising detection circuit 1191, of the five detection circuits provided on the magneto-optical disk unit 200. This designation makes it possible to perform a measurement of the time width by a newly designated detection circuit as well as the measurement of the rise time Tr by the already designated rising detection circuit 1191. Incidentally, it is possible to designate another detection circuit instead of the already designated rising detection circuit 1191.

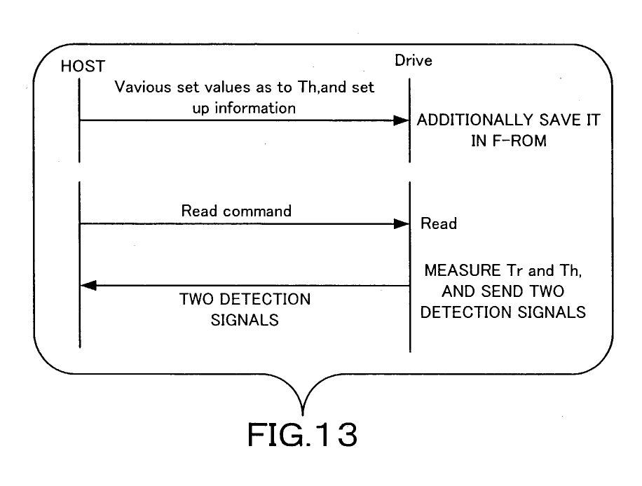

Here, in conjunction with FIG. 13, there will be described a case where a user designates on the personal computer 100 the “High” period detection circuit 1193 for measuring the H-level of time width Th as well as the already designated rising detection circuit 1191, and the user sets up the value of 4.75V as H-level of threshold for the “High” period detection circuit 1193 and also sets up values of the permissible minimum time width and the permissible maximum time width for the H-level of time width Th.

FIG. 13 is a view showing an outline of a flow of processing subsequent to the flow of the processing explained referring to FIG. 10.

When a designation of the new detection circuit is performed, the set up processing shown in FIG. 8 is executed again as processing for adding the new set up condition to the set up condition for the initial set up. Here, onto the F-ROM 212 of the magneto-optical disk unit 200, the value of 4.75V as H-level of threshold for the “High” period detection circuit 1193 is added, and values of the permissible minimum time width and the permissible maximum time width for the “High” period detection circuit 1193 are added, too.

Thus, after the new set up condition is added to the set up condition for the initial set up, transmission of the read command from the personal computer 100 causes the magneto-optical disk unit 200 to execute the read command processing shown in FIG. 10, so that both the detection signal representative of the monitor result by the rise detection circuit 1191 and the detection signal representative of the monitor result by the “High” period detection circuit 1193 are transmitted to the personal computer 100.

It is effective that a combination of the selected detection circuit is decided in view of the balance between a degree of reliability of data contents and a processing load. For example, it is acceptable that the rise detection circuit 1191 and the operating frequency detection circuit 1195 are used alternately, or alternatively those two circuits are simultaneously used.

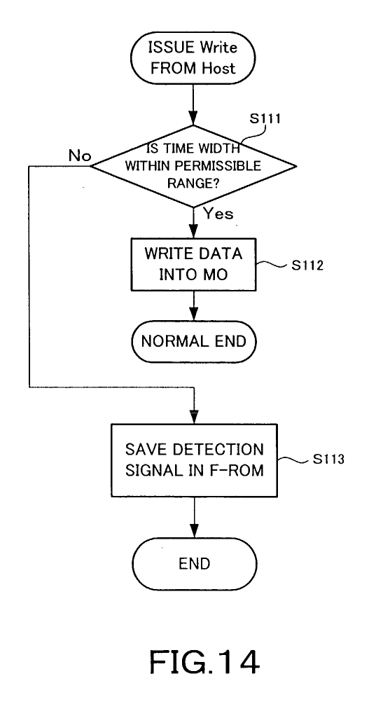

Next, in conjunction with FIG. 14, there will be explained a case where data of the personal computer 100 (host) shown in FIG. 2 is written into the magneto-optical disk loaded onto the magneto-optical disk unit 200 shown in FIG. 2, that is, a case where the magneto-optical disk unit 200 receives a write command from the host. In this case, the magneto-optical disk unit 200 is of the receiving side.

FIG. 14 is a flowchart useful for understanding write command processing of the magneto-optical disk upon receipt of the write command from the host.

In a similar fashion to that of the read command, the write command is transmitted from the personal computer 100 via the SCSI cable 300 to the portion of executing data transmission of the SCSI controller 216 of the magneto-optical disk unit 200. Write data into the magneto-optical disk and the data strobe signal are also transmitted together with the write command via the SCSI cable 300 to the portion of executing data transmission of the SCSI controller 216. The transmitted write data is fed to a data line (not illustrated) and is transmitted via the data line to the ODC 214 shown in FIG. 2. On the other hand, the data strobe signal, which is transmitted together with the write data, is fed to the data strobe line 1190. Of the detection circuits of the SCSI controller 216 of the magneto-optical disk unit 200, the detection circuit designated to be operated at the time of data transmission derives various types of values from the F-ROM 212, and measures time width of a predetermined section of a signal wave of a data strobe signal, just after the data strobe signal is fed to the data strobe line 1190, and decides whether the measured time width is between the derived permissible minimum time width and permissible maximum time width (step S111). As an execution timing of the step S111 is compared with execution timing of the parity check and CRC by the ODC 214 for the write data received in synchronism with the data strobe signal subjected to the decision in the step S111, the execution timing of the step S111 is faster. The F-ROM 212 of the magneto-optical disk unit 200 records information indicating that the detection circuits should output their associated monitor results in form of detection signals, respectively. When the decision is made in the step S111, the detection circuits output the detection signals each representative of the associated decision result. The outputted detection signals are transmitted to the CPU 211 of the magneto-optical disk unit 200 and the personal computer 100 as well. In the event that there is outputted the detection signal indicative of such a matter that the time width is within the permissible range, it is regarded that reliability of the received write data is high, and the ODC 214 shown in FIG. 2 writes the write data into the magneto-optical disk loaded onto the MO mounting slot 201a shown in FIG. 1 in accordance with the transmitted write command (step S112), and the write command processing is normally terminated. On the other hand, in the event that there is outputted the detection signal indicative of such a matter that the time width is out of the permissible range, the monitor result based on the detection signal is saved into the F-ROM 212 of the magneto-optical disk unit 200 (step S113), and the write command processing is terminated. In this case, reliability of the received write data is regarded low, and it is preferable that the CPU 211 of the magneto-optical disk unit 200 executes a host retry processing of requesting retransmission of the write data to the personal computer 100. It is acceptable that the above-mentioned statistics information is stored in a non-volatile storage of the magneto-optical disk and is utilized for confirmation of quality of transmission.

While the above-mentioned embodiments are concerned with a combination of the personal computer and the magneto-optical disk unit, the present invention can be widely adopted, not restricted to the storage such as the disk units, in electronic equipment provided with a parallel interface different from SCSI, for example, a computer system, an external storage, a communication apparatus, a transmission apparatus, a receiving apparatus, a transfer apparatus, an interface apparatus, transmission and receiving apparatus, etc., and also in electronic equipment provided with a serial interface.

As mentioned above, according to the present invention, it is possible to detect changes of contents of data due to noises and the like, independently of the parity check and the CRC, and request retransmission of the data promptly by reporting it to the data transmission source, and thereby preventing processing of erroneous data from being performed at the receiving end. Thus, according to the present invention, it is possible to possible to improve reliability of data transmission.

Although the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

What is claimed is:

1. A communication method comprising:
a data communication step that transmits and/or receiving both data and a synchronizing signal for data receiving, and
a synchronizing signal monitor step that monitors whether a time width of a predetermined section of a signal waveform of the synchronizing signal satisfies a predetermined reference.

2. A communication method according to claim 1, wherein said synchronizing signal monitor step monitors whether a time width of a predetermined section of the synchronizing signal is between a predetermined permissible minimum time width and a predetermined permissible maximum time width.

3. A communication method according to claim 1, wherein said synchronizing signal is a clock signal, and said synchronizing signal monitor step monitors, as the time width of the predetermined section, one or more selected from among a rise time, a fall time, a time width of an H-level, a time width of an L-level, and a predetermined transmission period, of the clock signal.

4. A communication method according to claim 1, wherein said communication method further comprises a receipt result report step that reports a monitored result by said synchronizing signal monitor step to a party of communications.

5. Electronic equipment comprising:
a data communication section that transmits and/or receiving both data and a synchronizing signal for data receiving, and
a synchronizing signal monitor section that monitors whether a time width of a predetermined section of a signal waveform of the synchronizing signal satisfies a predetermined reference.

6. Electronic equipment comprising:
a data receiving section that at least receives transmitted data in synchronism with a synchronizing signal transmitted together with the data, and
a synchronizing signal monitor section that monitors whether a time width of a predetermined section of a signal waveform of the transmitted synchronizing signal satisfies a predetermined reference.

7. Electronic equipment comprising:
a data transmission section that at least transmits data together with a synchronizing signal for data receiving, and
a synchronizing signal monitor section that monitors whether a time width of a predetermined section of a signal waveform of the transmitted synchronizing signal satisfies a predetermined reference.

8. Electronic equipment according to claim 5, further comprising a reference storage section that stores reference information representative of a permissible minimum time width and a permissible maximum time width of the predetermined section,
wherein said synchronizing signal monitor section monitors whether a time width of a predetermined section of the synchronizing signal is between the permissible minimum time width and the permissible maximum time width represented by the reference information stored in said reference storage section.

9. Electronic equipment according to claim 6, further comprising a reference storage section that stores reference information representative of a permissible minimum time width and a permissible maximum time width of the predetermined section,
wherein said synchronizing signal monitor section monitors whether a time width of a predetermined section of the synchronizing signal is between the permissible minimum time width and the permissible maximum time width represented by the reference information stored in said reference storage section.

10. Electronic equipment according to claim 7, further comprising a reference storage section that stores reference information representative of a permissible minimum time width and a permissible maximum time width of the predetermined section,
wherein said synchronizing signal monitor section monitors whether a time width of a predetermined section of the synchronizing signal is between the permissible minimum time width and the permissible maximum time width represented by the reference information stored in said reference storage section.

11. Electronic equipment according to claim 5, wherein said synchronizing signal is a clock signal, and said synchronizing signal monitor section monitors, as the time width of the predetermined section, one or more selected from among a rise time, a fall time, a time width of an H-level, a time width of an L-level, and a predetermined transmission period, of the clock signal.

12. Electronic equipment according to claim 6, wherein said synchronizing signal is a clock signal, and said synchronizing signal monitor section monitors, as the time width of the predetermined section, one or more selected from among a rise time, a fall time, a time width of an H-level, a time width of an L-level, and a predetermined transmission period, of the clock signal.

13. Electronic equipment according to claim 7, wherein said synchronizing signal is a clock signal, and said synchronizing signal monitor section monitors, as the time width of the predetermined section, one or more selected from among a rise time, a fall time, a time width of an H-level, a time width of an L-level, and a predetermined transmission period, of the clock signal.

14. Electronic equipment according to claim 5, wherein said electronic equipment further comprises a communication result report section that reports a monitored result by said synchronizing signal monitor section to a party of communications.

15. Electronic equipment according to claim 6, wherein said electronic equipment further comprises a communication result report section that reports a monitored result by said synchronizing signal monitor section to a party of communications.

16. Electronic equipment according to claim 7, wherein said electronic equipment further comprises a communication result report section that reports a monitored result by said synchronizing signal monitor section to a party of communications.

17. A communication program storage medium storing a communication program to be executed by electronic equipment having hardware for data communications and functions of executing programs, wherein said communication program causes said electronic equipment to perform the data communications, said electronic equipment comprising:
a data communication section that transmits and/or receiving both data and a synchronizing signal for data receiving, and
a synchronizing signal monitor section that monitors whether a time width of a predetermined section of a signal waveform of the synchronizing signal satisfies a predetermined reference.

18. A communication program storage medium storing a communication program to be executed by electronic equipment having hardware for data communications and functions of executing programs, wherein said communication program causes said electronic equipment to perform the data communications, said electronic equipment comprising:
a data receiving section that at least receives transmitted data in synchronism with a synchronizing signal transmitted together with the data, and
a synchronizing signal monitor section that monitors whether a time width of a predetermined section of a signal waveform of the transmitted synchronizing signal satisfies a predetermined reference.

19. A communication program storage medium storing a communication program to be executed by electronic equipment having hardware for data communications and functions of executing programs, wherein said communication program causes said electronic equipment to perform the data communications, said electronic equipment comprising:
a data transmission section that at least transmits data together with a synchronizing signal for data receiving, and
a synchronizing signal monitor section that monitors whether a time width of a predetermined section of a signal waveform of the transmitted synchronizing signal satisfies a predetermined reference.

20. A communication program storage medium according to claim 17, wherein said electronic equipment further comprises a reference storage section that stores reference information representative of a permissible minimum time width and a permissible maximum time width of the predetermined section, and
wherein said synchronizing signal monitor section monitors whether a time width of a predetermined section of the synchronizing signal is between the permissible minimum time width and the permissible maximum time width represented by the reference information stored in said reference storage section.

21. A communication program storage medium according to claim 17, wherein said synchronizing signal is a clock signal, and said synchronizing signal monitor section monitors, as the time width of the predetermined section, one or more selected from among a rise time, a fall time, a time width of an H-level, a time width of an L-level, and a predetermined transmission period, of the clock signal.

22. A communication program storage medium according to claim 18, wherein said synchronizing signal is a clock signal, and said synchronizing signal monitor section monitors, as the time width of the predetermined section, one or more selected from among a rise time, a fall time, a time width of an H-level, a time width of an L-level, and a predetermined transmission period, of the clock signal.

23. A communication program storage medium according to claim 19, wherein said synchronizing signal is a clock signal, and said synchronizing signal monitor section monitors, as the time width of the predetermined section, one or more selected from among a rise time, a fall time, a time width of an H-level, a time width of an L-level, and a predetermined transmission period, of the clock signal.

24. A communication program storage medium according to claim 17, wherein said electronic equipment further comprises a communication result report section that reports a monitored result by said synchronizing signal monitor section to a party of communications.

25. A communication program storage medium according to claim 18, wherein said electronic equipment further comprises a communication result report section that reports a monitored result by said synchronizing signal monitor section to a party of communications.

26. A communication program storage medium according to claim 19, wherein said electronic equipment further comprises a communication result report section that reports a monitored result by said synchronizing signal monitor section to a party of communications.
